(19) United States
(12) Patent Application Publication
(10) Pub. No.: US 2023/0350049 A1
(43) Pub. Date: Nov. 2, 2023

(54) FINGERTIP TRACKING USING RADAR

(71) Applicant: Google LLC, Mountain View, CA (US)

(72) Inventors: Anandghan Waghmare, Mountain View, CA (US); Dongeek Shin, Santa Clara, CA (US); Ivan Poupyrev, Los Altos, CA (US); Shwetak N. Patel, Seattle, WA (US); Shahram Izadi, Tiburon, CA (US); Adarsh Prakash Murthy Kowdle, San Francisco, CA (US)

(21) Appl. No.: 17/661,401

(22) Filed: Apr. 29, 2022

(51) Int. Cl. G01S 13/72; G01S 7/35; G06F 3/0338; G06F 3/01

(52) U.S. Cl. CPC G01S 13/723; G01S 7/35; G06F 3/0338; G06F 3/014; G06F 2203/0331

(57) ABSTRACT

A method including transmitting, by a peripheral device communicatively coupled to a wearable device, a frequency-modulated continuous wave (FMCW), receiving, by the peripheral device, a reflected signal based on the FMCW, tracking, by the peripheral device, a movement associated with the peripheral device based on the reflected signal, and communicating, from the peripheral device to the wearable device, an information corresponding to the movement associated with the peripheral device.

### FIELD

Example implementations relate to user input interfaces (e.g., a pointing device) in wearable devices including display(s).

### BACKGROUND

Head-worn computing devices (e.g., smart glasses) may be configured with a variety of sensors to enable augmented reality (AR), in which virtual elements are presented with real elements of an environment. The virtual elements may be presented on a heads-up display so they appear as if they were located in the real world. The heads-up display can be implemented in devices resembling eyeglasses (i.e., AR glasses). The head-worn computing devices can be communicatively coupled with user input interfaces for interacting with, for example, AR content displayed on the heads-up display.

### SUMMARY

In a general aspect, a device, a system, a non-transitory computer-readable medium (having stored thereon computer executable program code which can be executed on a computer system), and/or a method can perform a process with a method including transmitting, by a peripheral device communicatively coupled to a wearable device, a frequency-modulated continuous wave (FMCW), receiving, by the peripheral device, a reflected signal based on the FMCW, tracking, by the peripheral device, a movement associated with the peripheral device based on the reflected signal, and communicating, from the peripheral device to the wearable device, an information corresponding to the movement associated with the peripheral device.

In another general aspect, a device, a system, a non-transitory computer-readable medium (having stored thereon computer executable program code which can be executed on a computer system), and/or a method can perform a process with a method including receiving, by a wearable device from a peripheral device communicatively coupled to the wearable device, two or more reflected signals based on a frequency-modulated continuous wave (FMCW) generated by the peripheral device, and tracking, by the wearable device, a movement of the peripheral device based on the two or more reflected signals.

Implementations can include one or more of the following features. For example, the movement associated with the peripheral device can be at least one of movement of the peripheral device or movement of an object proximate to the peripheral device. The method can further include storing, by the peripheral device, an initial position of the peripheral device and determining, by the peripheral device, a cartesian coordinate based on the initial position associated with the peripheral device and the movement associated with the peripheral device, wherein the information includes the cartesian coordinate. The cartesian coordinate can be a one-dimensional (1D) coordinate variable. The cartesian coordinate can be a two-dimensional (2D) coordinate variable.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of a peripheral device movement tracking system according to an example embodiment.

FIG. 2 illustrates a block diagram of a peripheral device one-dimensional (1D) movement tracking system according to an example embodiment.

FIG. 3 illustrates a block diagram of a peripheral device two-dimensional (2D) movement tracking system according to an example embodiment.

FIG. 4 illustrates a block diagram of method for one-dimensional (1D) movement tracking associated with a peripheral device according to an example embodiment.

FIG. 5 illustrates a block diagram of method for two-dimensional (2D) movement tracking associated with a peripheral device according to an example embodiment.

FIG. 6 illustrates a block diagram of a peripheral device movement tracking system according to an example embodiment.

FIG. 7 shows an example of a computer device and a mobile computer device according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Computing devices (e.g., personal computer, laptop computer, and the like) can have a large selection of peripheral devices available for user input. Mice, keyboards, trackballs, touchpads, and light pens are just a few examples of peripheral devices available for user input for computer devices. By contrast, wearable computing devices (e.g., augmented reality (AR) and virtual reality (AR) devices) can have a limited selection of peripheral device(s) available for user input. For example, AR glasses (e.g., in an eyeglasses form factor) may have limited or no peripheral devices available for user input. The lack of peripheral devices available for user input can limit the functionality of the AR glasses for a user.

Example implementations can include a peripheral device configured to provide user input for wearable computing devices (hereinafter referred to as a wearable device). The peripheral device can have a form factor that a user of the wearable device may be used to wearing (e.g., a watch, a ring, a glove, a bracelet, and/or the like). The peripheral device can be configured to generate signals similar to typical peripheral devices available for computing devices. For example, the peripheral device can be configured to generate a signal for click/scroll input, slide bar (e.g., volume control) input, application specific input (e.g., draw shapes, letters, and/or the like).

Accordingly, example implementations can include a peripheral device configured to generate and/or detect extremely sensitive, millimeter movements of the peripheral device and/or object proximate to the peripheral device. For example, a ring form factor can be configured to detect millimeter fingertip movements (e.g., movement of the thumb relative to the index finger and/or fingertip) with an impression that the user is controlling a virtual touchpad. For example, a glove form factor can be configured to detect movements mimicking a user typing on a keyboard.

In an example implementation, the peripheral device can be communicatively coupled to a wearable device. The peripheral device can be configured to generate and transmit a frequency-modulated continuous wave (FMCW). The peripheral device can be configured to receive a reflected signal (e.g., a signal reflected from an object that is proximate to the peripheral device) based on the FMCW. The peripheral device and/or the wearable device can be configured to track a movement associated with the peripheral device (e.g., movement of the peripheral device and/or an object proximate to the peripheral device) based on the reflected signal. The peripheral device can be of a form factor that the user of the wearable device may be used to wearing (e.g., a watch, a ring, a glove, a bracelet, and/or the like). Therefore, the object proximate to the peripheral device can be a body part (e.g., hand, finger, thumb, and/or the like).

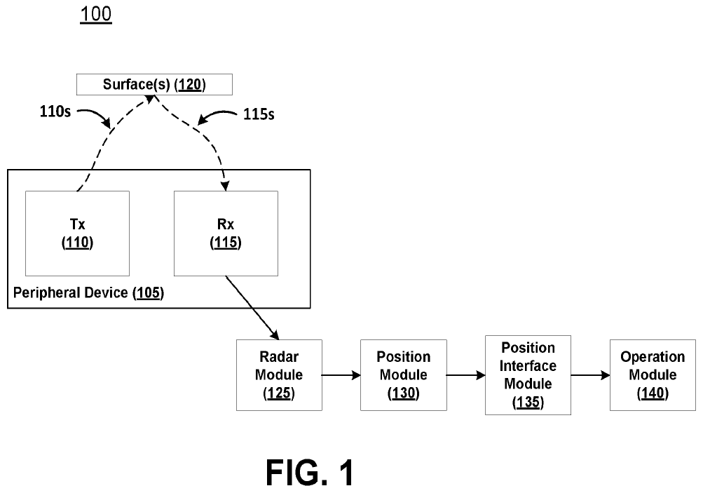

FIG. 1 illustrates a block diagram of a peripheral device movement tracking system according to an example embodiment. As shown in FIG. 1, the system 100 includes a peripheral device 105 and a surface(s) 120. The peripheral device 105 can include a transmitter(s) 110 and a receiver(s) 115. The system 100 can further include a radar module 125 block, a position module 130 block, a position interface module 135 block, and an operation module 140 block. The radar module 125, the position module 130, the position interface module 135, and the operation module 140 can be located, positioned, disposed, and/or the like in the peripheral device 105, a wearable device (not shown), a companion device (e.g., a mobile device, a tablet, a cell phone, and/or the like), and/or any combination thereof. For example, the radar module 125 can be in the peripheral device 105, the position module 130 and the position interface module 135 can be in the companion device, and the operation module 140 can be in the wearable device. This example is just one of many example configurations of the system 100.

The transmitter(s) 110 can be configured to transmit a signal 110s (e.g., a wave) that can reflect off of the surface(s) 120 and the receiver(s) 115 can be configured to receive the reflected signal 115s. The radar module 125 can be configured to determine information associated with the reflected signal 115s. For example, the information associated with the reflected signal 115s can include time information (e.g., a time delta between the transmission of signal 110s and the reception of the reflected signal 115s. The information associated with the reflected signal 115s can include a distance (e.g., a distance between the peripheral device and the surface based on the time delta). The information associated with the reflected signal 115s can include an angle (e.g., an angle of arrival of the reflected signal 115s at the receiver(s) 115). The information associated with the reflected signal 115s can include a number of surface(s) 120 (e.g., the signal 110s can reflect off of one or more of surface(s) 120 causing one or more signal 115s to be received by the receiver(s) 115).

The peripheral device 105 can be of a form factor that the user of the wearable device may be used to wearing (e.g., a watch, a ring, a glove, a bracelet, and/or the like). Further, surface(s) 120 can be or can include the object that is proximate to the peripheral device 105. The surface(s) 120 can be or can include a body part (e.g., hand, finger, thumb, and/or the like) as the object and/or a portion of the object. The peripheral device 105 can be configured to track a movement of the peripheral device 105 and/or of the surface(s) 120 based on the signal 110s and/or the reflected signal 115s.

The position module 130 can be configured to determine a position and/or a position change associated with at least one of the peripheral device 105 and/or the surface(s) 120. The position module 130 can be configured to determine a cartesian coordinate based on the information associated with the reflected signal 115s. The cartesian coordinate can be a one-dimensional (1D) and/or a two-dimensional (2D) coordinate. The radar module 125 and/or the position module 130 can be configured to use the Doppler effect and/or Doppler shift. The Doppler effect and/or Doppler shift can describe the changes in frequency of any kind of wave (e.g., the signal 110s) produced by a moving source (e.g., the transmitter(s) 110) with respect to an observer (e.g., receiver(s) 115). Waves emitted by an object (e.g., surface(s) 120) traveling toward the observer (e.g., receiver(s) 115) can get compressed causing a higher frequency wave (e.g., reflected signal 115s) as the source (e.g., surface(s) 120) approaches the observer (e.g., receiver(s) 115). In an example implementation, the peripheral device 105 and/or the surface(s) 120 can be moving causing the Doppler effect and/or Doppler shift.

The position interface module 135 can be configured to provide a communicative interface between a wearable device and the device (e.g., the peripheral device 105 or a companion device) for the purpose of communicating the position and/or a position change to the wearable device. The operation module 140 can be configured to perform an operation on the wearable device based on the position and/or a position change. For example, the position and/or a position change can indicate a user action to change a volume of a speaker of the wearable device. The operation module 140 can cause the volume of the speaker to increase or decrease based on the position and/or a position change as determined by the position module 130.

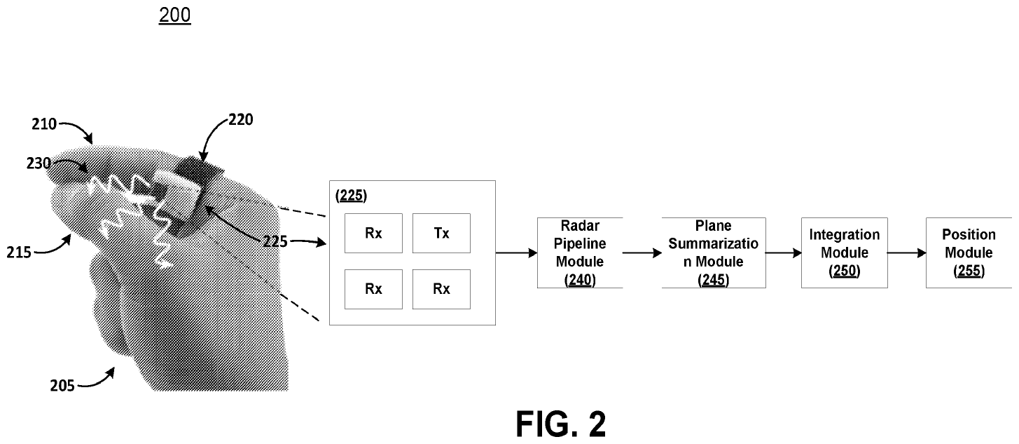

FIG. 2 illustrates a block diagram of a peripheral device one-dimensional (1D) movement tracking system according to an example embodiment. As shown in FIG. 2, the system 200 includes a peripheral device 220, an antenna 225 block, a radar pipeline module 240 block, a plane summarization 245 block, an integration module 250 block, and a position module 255 block. The peripheral device 220 is illustrated in the form factor of a ring. The peripheral device 220 is placed or positioned on a first finger 210 (e.g., index finger) of a hand 205.

In the example implementation of FIG. 2, a second finger 215 (e.g., the thumb) can move in reference to the first finger 210. In this case, the first finger 210 operates like a touchpad and the second finger 215 operates like an object (often a finger) moving on the touchpad. The antenna 225 includes transmitter(s) Tx and receiver(s) Rx each of which can be an antenna. The transmitter(s) Tx can be configured to transmit a signal 230 (e.g., a wave) that can reflect off of the second finger 215. The receiver(s) Rx can be configured to receive the signal reflected off of the second finger 215. In the example of FIG. 2 tracking can be a 1D tracking.

The radar pipeline module 240 can be configured to cause the antenna 225 to emit electromagnetic waves in a broad beam. Objects, such as a hand 205, within the beam scatter this energy, reflecting some portion back towards the antenna 225. Properties of the reflected signal, such as energy, time delay, and frequency shift can indicate information about the object's characteristics and behaviors, including size, shape, orientation, material, distance and velocity.

The radar pipeline module 240 can be configured to cause the antenna 225 to emit a signal (e.g., electromagnetic wave) using the transmitter(s) Tx, receive a reflected signal (e.g., electromagnetic wave) using receiver(s) Rx, and process the reflected signal to determine characteristics of the reflected signal. For example, the radar pipeline module 240 can be configured to process temporal signal variations and other captured characteristics of the reflected signal. The radar pipeline module 240 can be configured to distinguish between complex movements to determine, for example, the size, shape, orientation, material, distance, and velocity of the object (e.g., finger 215) within the field of antenna 225. The radar pipeline module 240 can be configured to use the Doppler effect and/or Doppler shift. The Doppler effect and/or Doppler shift can describe the changes in frequency of any kind of wave (e.g., the Tx signal) produced by a moving source (e.g., the Tx) with respect to an observer (e.g., the Rx).

The radar pipeline module 240 can be configured to generate a plurality of planes representing the many objects and/or portions of objects that cause a reflected signal. However, some, or even most of these planes may be of little interest to peripheral device 220 for the purposes of providing input to a wearable device. Therefore, the plane summarization module 245 can be configured to filter (e.g., remove) planes that are not relevant to the peripheral device 220 for the purposes of providing input to the wearable device. The filter can be implemented using range-doppler gating. Range-doppler gating first computes the range-doppler image, and then only extract the signal in the relevant sub-region of the range-doppler (e.g., the thumb from index is generally separated by X cm and moves at Y cm/s) for further processing and discard the other parts or regions.

The plane summarization module 245 and/or the radar pipeline module 240 can be configured to use a Doppler cue technique to identify the plane(s) of interest. A Doppler cue technique can include identifying a position corresponding to an object and/or a portion of an object that is to be tracked. The plane summarization module 245 can use the Doppler cue in the filtering process and the radar pipeline module 240 can use the Doppler cue to focus the antenna 225 direction and/or trigger operation (e.g., start transmitting signal 230) of the antenna 225.

For example, signal 230 can reflect off of the knuckle of finger 125, the hand 205, and/or other objects that may be proximate to the peripheral device 220. However, the peripheral device 220 may only use movement of finger 215 where finger 215 touches finger 210 (e.g., at the fingertip of finger 215). Therefore, the plane summarization module 245 can be configured to filter planes associated with the knuckle of finger 125, the hand 205, and/or other objects that may be proximate to the peripheral device 220 out of any dataset and keep a plane associated with finger 215 where finger 215 touches finger 210.

The integration module 250 can be configured to integrate temporal reflected signal variations. In other words, the integration module 250 can be configured to generate a time integral of the input reflected (and filtered) signal. The integration module 250 can be configured to accumulate the input reflected over a defined time to produce a representative output. In an example implementation, the representative output of the integration module 250 can represent a position which is then stored and tracked in the position module 255. The position module 255 can be configured to convert the output representing the position to a 1D coordinate. Accordingly, the position module 255 can be configured to track a position of an object associated with the peripheral device 220. In an example implementation, the position module 255 can be configured to track a position and/or a change in position of finger 215 in relation to finger 210. The position can be or can include a 1D coordinate.

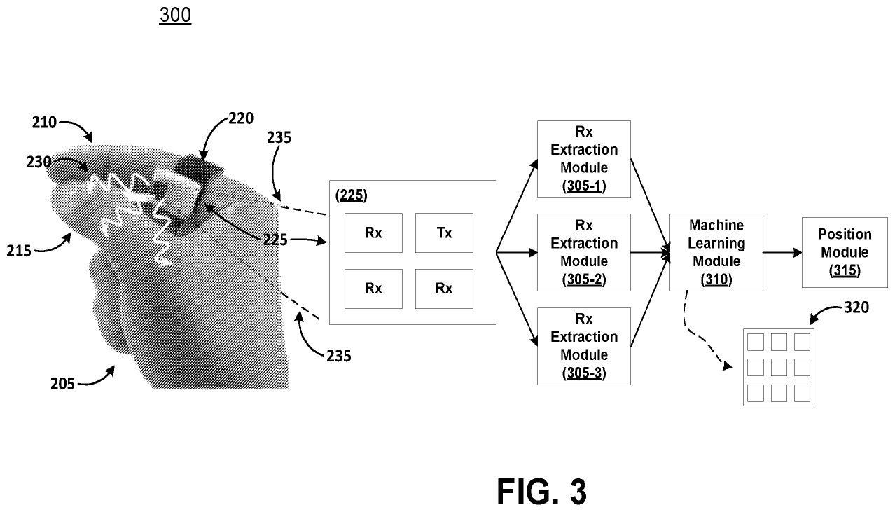

FIG. 3 illustrates a block diagram of a peripheral device two-dimensional (2D) movement tracking system according to an example embodiment. As shown in FIG. 3, the system 300 includes the peripheral device 220, the antenna 225 block, Rx extraction module 305-1, 305-2, 305-3 blocks, a machine learning module 310 block, and a position module 315 block. As discussed above, the peripheral device 220 is illustrated in the form factor of a ring. The peripheral device 220 is placed or positioned on a first finger 210 (e.g., index finger) of a hand 205.

In the example implementation of FIG. 3, a second finger 215 (e.g., the thumb) can move in reference to the first finger 210. In this case, the first finger 210 operates like a touchpad and the second finger 215 operates like an object (often a finger) moving on the touchpad. The antenna 225 includes transmitter(s) Tx and receiver(s) Rx each of which can be an antenna. The transmitter(s) Tx can be configured to transmit a signal 230 (e.g., a wave) that can reflect off of the second finger 215. The receiver(s) Rx can be configured to receive the signal reflected off of the second finger 215. In the example of FIG. 3 tracking can be a 2D tracking.

The Rx extraction module 305-1, 305-2, 305-3 can be configured to extract the reflected signal for each from a receiver Rx. Antenna 225 shows three (3) receivers Rx. Therefore, three (3) Rx extraction modules 305-1, 305-2, 305-3. However, three (3) receivers Rx are shown for example purposes, more or fewer receivers Rx are within the scope of this disclosure. Therefore, more or fewer Rx extraction modules 305-1, 305-2, 305-3 are within the scope of this disclosure. Each receiver Rx can be referred as a channel. Therefore, Rx extraction module 305-1 can be associated with a first channel (e.g., channel #1), Rx extraction module 305-1 can be associated with a second channel (e.g., channel #2), and Rx extraction module 305-3 can be associated with a third channel (e.g., channel #3).

Extracting a reflected signal can include filtering unwanted signals. As discussed above, signal 230 can reflect off of the knuckle of finger 125, the hand 205, and/or other objects that may be proximate to the peripheral device 220. However, the peripheral device 220 may only use movement of finger 215 where finger 215 touches finger 210 (e.g., at the fingertip of finger 215). Therefore, the Rx extraction module 305-1, 305-2, 305-3 can be configured to filter signals associated with the knuckle of finger 125, the hand 205, and/or other objects that may be proximate to the peripheral device 220 out of any dataset and keep a reflected signal associated with finger 215 where finger 215 touches finger 210. The filter can be implemented using range-doppler gating. Range-doppler gating first computes the range-doppler image, and then only extract the signal in the relevant sub-region of the range-doppler (e.g., the thumb from index is generally separated by X cm and moves at Y cm/s) for further processing and discard the other parts or regions.

The Rx extraction module 305-1, 305-2, 305-3 can be configured to use the Doppler effect and/or Doppler shift. The Doppler effect and/or Doppler shift can describe the changes in frequency of any kind of wave (e.g., the Tx signal) produced by a moving source (e.g., the Tx) with respect to an observer (e.g., the Rx). The Rx extraction module 305-1, 305-2, 305-3 can be configured to use a Doppler cue technique to identify the signal(s) of interest. A Doppler cue technique can include identifying a position corresponding to an object and/or a portion of an object that is to be tracked.

The machine learning module 310 can be configured to use a trained model that can use the output of the Rx extraction module 305-1, 305-2, 305-3 and generate a position. The generated position can be a 2D position. 3×3 grid 320 shows an example 2D position grid. The machine learning module 310 can be trained to determine a set of reflected signals output from the Rx extraction module 305-1, 305-2, 305-3 corresponds to a position of one of the nine (9) blocks. Although 9 blocks are shown in the 3×3 grid 320, example implementations are not limited thereto. In an example implementation, the representative output of the machine learning module 310 can represent a position which is then stored and tracked in the position module 315. The position module 315 can be configured to convert the output representing the position to a 2D coordinate. Accordingly, the position module 315 can be configured to track a position of an object associated with the peripheral device 220. In an example implementation, the position module 315 can be configured to track a position and/or a change in position of finger 215 in relation to finger 210. The position can be or can include a 2D coordinate.

The trained model can be configured to predict a 2D position based on the input reflected signals. Therefore, the trained model can predict two numeric values (e.g., an x position and a y position). The trained model can be a neural network (e.g., a convolutional neural network). The trained model can operate as a regressive inference. Therefore, the neural network can include a regression layer and/or a sigmoid activations.

The trained model can include at least one convolution. The trained model can be configured to predict a 2D position. Therefore, the convolution can be a 2D convolution. The convolution can be configured to generate an embedding including a plurality of vectors. The number of vectors can be based on a number of positions (e.g., the nine (9) positions of the 3×3 grid 320). Thus, each vector can correspond to a respective position.

A convolution can be configured to extract features from information representing the reflected signal. Features can be based on temporal signal variations, energy, time delay, frequency shift, size, shape, orientation, material, distance and velocity of an object within a field of the signal 230. A convolution can have a filter (sometimes called a kernel) and a stride. For example, a filter can be a 1×1 filter (or 1×1×n for a transformation to n output channels, a 1×1 filter is sometimes called a pointwise convolution) with a stride of 1 which results in an output of a cell generated based on a combination (e.g., addition, subtraction, multiplication, and/or the like) of the features of the cells of each channel at a position of the M×M grid. In other words, a feature map having more than one depth or channel is combined into a feature map having a single depth or channel. A filter can be a 3×3 filter with a stride of 1 which results in an output with fewer cells in/for each channel of the M×M grid or feature map. The output can have the same depth or number of channels (e.g., a 3×3×n filter, where n=depth or number of channels, sometimes called a depthwise filter) or a reduced depth or number of channels (e.g., a 3×3×k filter, where k<depth or number of channels). Each channel, depth, or feature map can have an associated filter. Each associated filter can be configured to emphasize different aspects of a channel (e.g., output of each of the Rx extraction module 305-1, 305-2, 305-3). In other words, different features can be extracted from each channel based on the filter (this is sometimes called a depthwise separable filter). Other filters are within the scope of this disclosure.

Another type of convolution can be a combination of two or more convolutions, sometimes called a blended convolution. For example, a convolution can be a depthwise and pointwise separable convolution. This can include, for example, a convolution in two steps. The first step can be a depthwise convolution (e.g., a 3×3 convolution). The second step can be a pointwise convolution (e.g., a 1×1 convolution). The depthwise and pointwise convolution can be a separable convolution in that a different filter (e.g., filters to extract different features) can be used for each channel or each depth of a feature map.

A convolution can be linear. A linear convolution describes the output, in terms of the input, as being linear time-invariant (LTI). Convolutions can also include a rectified linear unit (ReLU). A ReLU is an activation function that rectifies the LTI output of a convolution and limits the rectified output to a maximum. A ReLU can be used to accelerate convergence (e.g., result in more efficient training of the model).

Training the trained model of the machine learned module 310 can include modifying weights associated with a convolution. The trained model can be trained for distinguishing between features and identifying relationships between features. Features and relationships between features can help predict positions. For example, time delay, frequency shift and the relationship between time delay an frequency shift can indicate a position and/or a change in position of finger 215 in relation to finger 210. Each convolution can have an associated weight. The associated weights can be randomly initialized and then revised in each training iteration (e.g., epoch).

The training can be associated with implementing (or helping to implement) distinguishing between features and identifying relationships between features. In an example implementation, labelled input data (e.g., a dataset including labelled positions) and the predicted position can be compared. A loss can be generated based on the difference between the labelled position and the predicted position. Training iterations can continue until the loss is minimized and/or until loss does not change significantly from iteration to iteration. In an example implementation, the lower the loss, the better the predicted position(s).

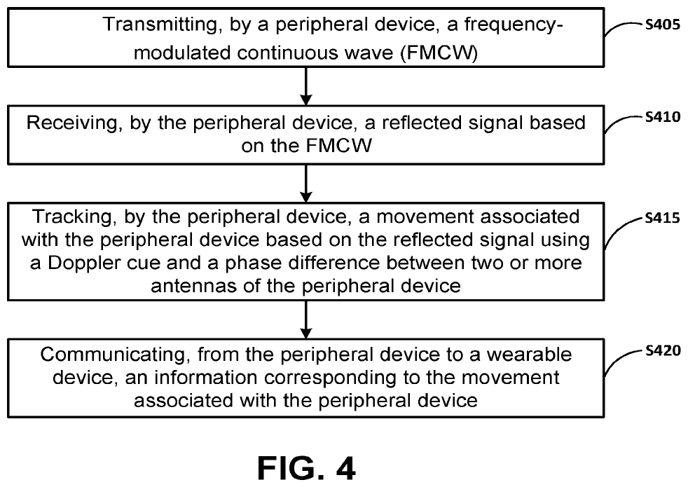

FIG. 4 illustrates a block diagram of method for one-dimensional (1D) movement tracking associated with a peripheral device according to an example embodiment. As shown in FIG. 4, in step S405 a frequency-modulated continuous wave (FMCW) is transmitted (sometimes called emitted) by a peripheral device. For example, the peripheral device can include a transmit (Tx) antenna. The Tx antenna can be configured to transmit a signal based on or as a FMCW. A FMCW can be a radio frequency (RF) signal that is swept linearly in frequency. The FMCW can have a frequency that is an instantaneous frequency that varies linearly over a fixed period of time (sweep time) by a modulating (in frequency or in phase) signal.

In step S410 a reflected signal based on the FMCW is received by the peripheral device. For example, the peripheral device can include a receive (Rx) antenna. The Rx antenna can be configured to receive a reflected signal generated by the FMCW reflecting off of an object. In an example implementation, the object can be proximate to the peripheral device. For example, the peripheral device can be on a first finger and the proximate object can be a second finger.

In step S415 a movement associated with the peripheral device is tracked by the peripheral device. The movement can be based on the reflected signal using a Doppler cue and a phase difference between two or more antennas of the peripheral device. For example, the transmitted signal (e.g., FMCW) can be mixed with the reflected signal. A difference in frequency between the transmitted signal and the reflected signal can be determined based on the mixed signal. the difference in frequency can be used to determine distance and/or velocity. The movement can be based on changes in distance and/or velocity over time.

In step S420 an information corresponding to the movement associated with the peripheral device is communicated from the peripheral device to a wearable device. For example, the movement can be based on and/or converted to a one-dimensional (1D) cartesian coordinate system. The information corresponding to the movement can include raw data, a position, a coordinate, a change in raw data, a change in position, a change in coordinate, and/or the like. The information corresponding to the movement can be communicated wirelessly to a communicatively coupled (e.g., via a wireless communication standard such as Bluetooth, WiFi, and/or the like) wearable device.

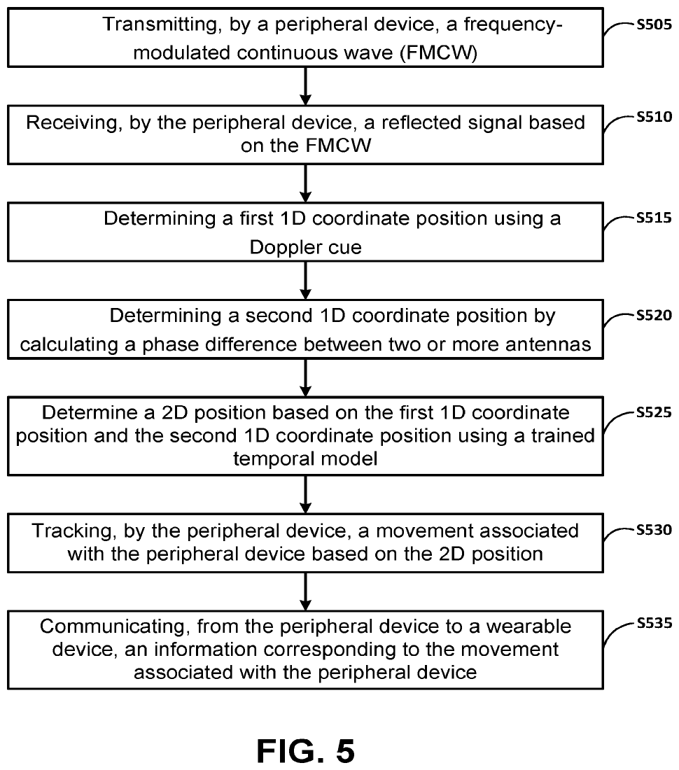

FIG. 5 illustrates a block diagram of method for two-dimensional (2D) movement tracking associated with a peripheral device according to an example embodiment. As shown in FIG. 5, in step S505 a frequency-modulated continuous wave (FMCW) is transmitted (sometimes called emitted) by a peripheral device. For example, the peripheral device can include a transmit (Tx) antenna. The Tx antenna can be configured to transmit a signal based on or as a FMCW. A FMCW can be a radio frequency (RF) signal that is swept linearly in frequency. The FMCW can have a frequency that is an instantaneous frequency that varies linearly over a fixed period of time (sweep time) by a modulating (in frequency or in phase) signal.

In step S510 a reflected signal based on the FMCW is received by the peripheral device. For example, the peripheral device can include a receive (Rx) antenna. The Rx antenna can be configured to receive a reflected signal generated by the FMCW reflecting off of an object. In an example implementation, the object can be proximate to the peripheral device. For example, the peripheral device can be on a first finger and the proximate object can be a second finger.

In step S515 a first 1D coordinate position is determined using a Doppler cue. For example, a Doppler cue technique can include identifying a position corresponding to an object and/or a portion of an object that is to be tracked. The Doppler cue can be used to identify a position along a first axis (e.g., the x or y axis) in a 2D cartesian coordinate system.

In step S520 a second 1D coordinate position is determined by calculating a phase difference between two or more antennas. For example, the transmitted signal (e.g., FMCW) can be mixed with the reflected signal. A difference in phase between the transmitted signal and the reflected signal can be determined based on the mixed signal. The difference in phase can be used to determine a distance along a second axis (e.g., the x or y axis) in the 2D cartesian coordinate system.

In step S525 a 2D position based on the first 1D coordinate position and the second 1D coordinate position is determined using a trained temporal model. For example, the first 1D coordinate position can be along the y axis in the 2D cartesian coordinate system and the second 1D coordinate position can be along the x axis in the 2D cartesian coordinate system. Therefore, the 2D position can be the combination of the position along the x axis and the position along the y axis.

In step S530 a movement associated with the peripheral device is tracked by the peripheral device. The movement can be based on the 2D position. The movement can be based on changes in direction and/or distance over time. The movement can be a delta value. The movement can include a velocity value (e.g., how fast the position is changing). The movement can be tracked for a period of time.

In step S535 an information corresponding to the movement associated with the peripheral device is communicated from the peripheral device to a wearable device. For example, the movement can be based on and/or converted to a one-dimensional (1D) cartesian coordinate system. The information corresponding to the movement can include raw data, a position, a coordinate, a change in raw data, a change in position, a change in coordinate, and/or the like. The information corresponding to the movement can be communicated wirelessly to a communicatively coupled (e.g., via a wireless communication standard such as Bluetooth, WiFi, and/or the like) wearable device.

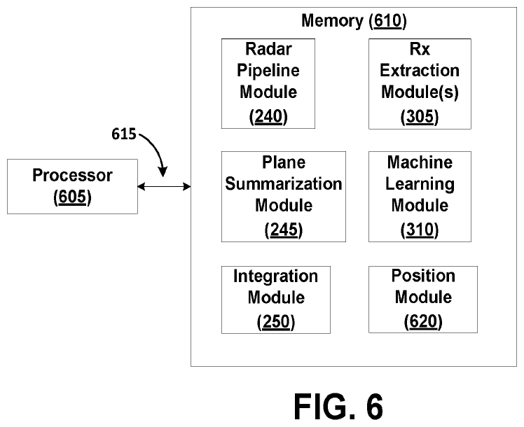

FIG. 6 illustrates a block diagram of a peripheral device movement tracking system according to an example embodiment.

In the example of FIG. 6, the peripheral device movement tracking system can include a computing system or at least one computing device and should be understood to represent virtually any computing device configured to perform the techniques described herein. As such, the device may be understood to include various components which may be utilized to implement the techniques described herein, or different or future versions thereof. By way of example, the system can include a processor 605 and a memory 610 (e.g., a non-transitory computer readable memory). The processor 605 and the memory 610 can be coupled (e.g., communicatively coupled) by a bus 615.

The processor 605 may be utilized to execute instructions stored on the at least one memory 610. Therefore, the processor 605 can implement the various features and functions described herein, or additional or alternative features and functions. The processor 605 and the at least one memory 610 may be utilized for various other purposes. For example, the at least one memory 610 may represent an example of various types of memory and related hardware and software which may be used to implement any one of the modules described herein.

The at least one memory 610 may be configured to store data and/or information associated with the device. The at least one memory 610 may be a shared resource. Therefore, the at least one memory 610 may be configured to store data and/or information associated with other elements (e.g., image/video processing or wired/wireless communication) within the larger system. Together, the processor 605 and the at least one memory 610 may be utilized to implement the techniques described herein. As such, the techniques described herein can be implemented as code segments (e.g., software) stored on the memory 610 and executed by the processor 605. Accordingly, the memory 610 can include the radar pipeline module 240, the plane summarization module 245, the integration module 250, the Rx extraction module(s) 305, the machine learning module 310, and a position module 620.

As discussed above, the radar pipeline module 240 can be configured to cause the antenna 225 to emit a signal (e.g., electromagnetic wave) using the transmitter(s) Tx, receive a reflected signal (e.g., electromagnetic wave) using receiver(s) Rx, and process the reflected signal to determine characteristics of the reflected signal. The plane summarization module 245 can be configured to filter (e.g., remove) planes that are not relevant to the peripheral device 220 for the purposes of providing input to the wearable device. The integration module 250 can be configured to integrate temporal reflected signal variations. The integration module 250 can be configured to generate a 1D position. The Rx extraction module(s) 305 can be configured to extract the reflected signal for each from a receiver Rx. The Rx extraction module(s) 305 can be configured to filter (e.g., remove) signals that are not relevant to the peripheral device 220 for the purposes of providing input to the wearable device. The machine learning module 310 use a trained model that can use the output of the Rx extraction module 305-1, 305-2, 305-3 and generate a position. The generated position can be a 2D position. The position module 620 can be configured to track a position of an object associated with the peripheral device 220. The position module 620 can be and/or include the position module 255 for 1D tracking and the position module 315 for 2D tracking.

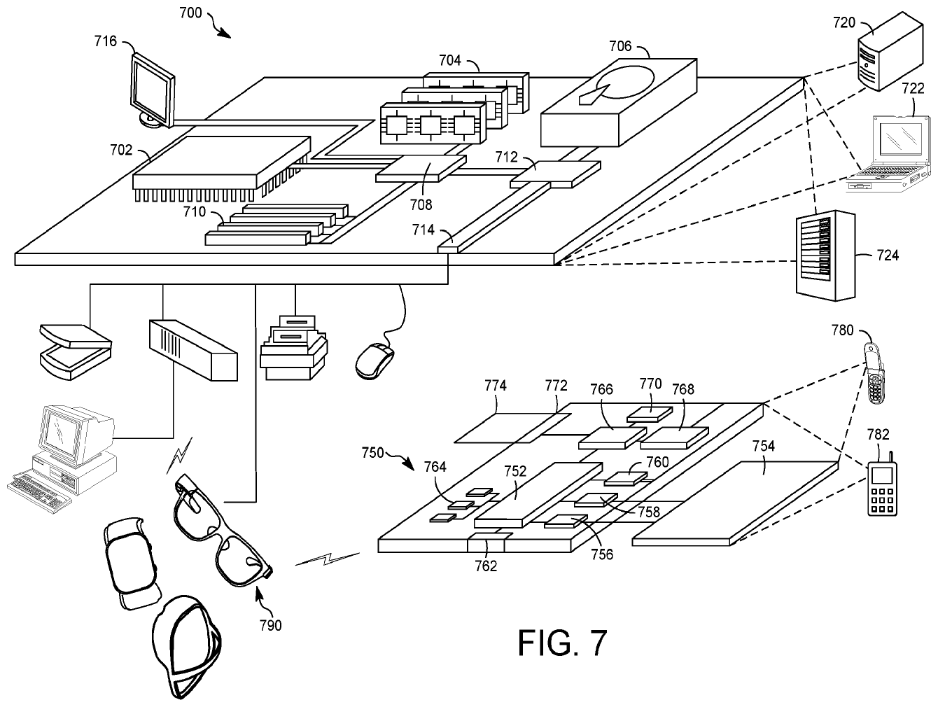

FIG. 7 illustrates an example of a computer device 700 and a mobile computer device 750, which may be used with the techniques described here. The computing device 700 includes a processor 702, memory 704, a storage device 706, a high-speed interface 708 connecting to memory 704 and high-speed expansion ports 710, and a low-speed interface 712 connecting to low-speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high-speed controller 708 manages bandwidth-intensive operations for the computing device 700, while the low-speed controller 712 manages lower bandwidth-intensive operations. Such allocation of functions is example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display), and LED (Light Emitting Diode) or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In-Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 790 to generate an augmented environment for viewing inserted content within the physical space. For example, one or more sensors included on a computing device 750 or other computing device depicted in the figure, can provide input to the AR headset 790 or in general, provide input to an AR space. The sensors can include, but are not limited to, a touch screen, accelerometers, gyroscopes, pressure sensors, biometric sensors, temperature sensors, humidity sensors, and ambient light sensors. The computing device 750 can use the sensors to determine an absolute position and/or a detected rotation of the computing device in the AR space that can then be used as input to the AR space. For example, the computing device 750 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 750 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 750 when the computing device is incorporated into the AR space can cause a particular action to occur in the AR space.

In some implementations, a touchscreen of the computing device 750 can be rendered as a touchpad in AR space. A user can interact with the touchscreen of the computing device 750. The interactions are rendered, in AR headset 790 for example, as movements on the rendered touchpad in the AR space. The rendered movements can control virtual objects in the AR space.

In some implementations, one or more output devices included on the computing device 750 can provide output and/or feedback to a user of the AR headset 790 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 750 may appear as another object in a computer-generated, 3D environment. Interactions by the user with the computing device 750 (e.g., rotating, shaking, touching a touchscreen, swiping a finger across a touch screen) can be interpreted as interactions with the object in the AR space. In the example of the laser pointer in an AR space, the computing device 750 appears as a virtual laser pointer in the computer-generated, 3D environment. As the user manipulates the computing device 750, the user in the AR space sees movement of the laser pointer. The user receives feedback from interactions with the computing device 750 in the AR environment on the computing device 750 or on the AR headset 790. The user's interactions with the computing device may be translated to interactions with a user interface generated in the AR environment for a controllable device.

In some implementations, a computing device 750 may include a touchscreen. For example, a user can interact with the touchscreen to interact with a user interface for a controllable device. For example, the touchscreen may include user interface elements such as sliders that can control properties of the controllable device.

Computing device 700 is intended to represent various forms of digital computers and devices, including, but not limited to laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific tel las) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method comprising:
transmitting, by a peripheral device communicatively coupled to a wearable device, a frequency-modulated continuous wave (FMCW);
receiving, by the peripheral device, a reflected signal based on the FMCW;
tracking, by the peripheral device, a movement associated with the peripheral device based on the reflected signal; and
communicating, from the peripheral device to the wearable device, an information corresponding to the movement associated with the peripheral device.

2. The method of claim 1, wherein the movement associated with the peripheral device is at least one of movement of the peripheral device or movement of an object proximate to the peripheral device.

3. The method of claim 1, further comprising:
storing, by the peripheral device, an initial position of the peripheral device; and
determining, by the peripheral device, a cartesian coordinate based on the initial position associated with the peripheral device and the movement associated with the peripheral device, wherein the information includes the cartesian coordinate.

4. The method of claim 3, wherein the cartesian coordinate is a one-dimensional (1D) coordinate variable.

5. The method of claim 3, wherein the cartesian coordinate is a two-dimensional (2D) coordinate variable.

6. A method comprising:
receiving, by a wearable device from a peripheral device communicatively coupled to the wearable device, two or more reflected signals based on a frequency-modulated continuous wave (FMCW) generated by the peripheral device; and
tracking, by the wearable device, a movement of the peripheral device based on the two or more reflected signals.

7. The method of claim 6, wherein the movement associated with the peripheral device is at least one of movement of the peripheral device or movement of an object proximate to the peripheral device.

8. The method of claim 6, further comprising:
storing, by the peripheral device, an initial position of the peripheral device; and
determining, by the peripheral device, a cartesian coordinate based on the initial position associated with the peripheral device and the movement associated with the peripheral device, wherein the information includes the cartesian coordinate.

9. The method of claim 8, wherein the cartesian coordinate is a one-dimensional (1D) coordinate variable.

10. The method of claim 8, wherein the cartesian coordinate is a two-dimensional (2D) coordinate variable.
